(19) United States
(12) Patent Application Publication
(10) Pub. No.: US 2015/0032666 A1
(43) Pub. Date: Jan. 29, 2015

(54) POWER MANAGEMENT SYSTEM AND NON-TRANSITORY COMPUTER READABLE MEDIUM

(71) Applicant: FUJI XEROX CO., LTD., Tokyo (JP)

(72) Inventor: Atsushi TOGO, Yokohama-shi (JP)

(73) Assignee: FUJI XEROX CO., LTD., Tokyo (JP)

(21) Appl. No.: 14/288,574

(22) Filed: May 28, 2014

(30) Foreign Application Priority Data
Jul. 23, 2013 (JP) 2013-152415

(51) Int. Cl. G06Q 50/06; G06Q 30/02

(52) U.S. Cl. CPC G06Q 50/06; G06Q 30/0202
USPC 705/412

(57) ABSTRACT

A power management system includes following components. A detector detects one or more devices which are located within an area. A demand estimation unit estimates an electric power demand in the area, based on the detected devices. A distribution unit distributes an area power-saving target value to the area, based on the estimated electric power demand and an overall power-saving target value. In response to a change in a state of the devices in the area to which the area power-saving target value has been distributed, the demand estimation unit estimates an updated electric power demand, based on the state of the devices that has changed. The distribution unit updates the area power-saving target value, based on the estimated updated electric power demand, and distributes the updated area power-saving target value to the area.

### CROSS-REFERENCE TO RELATED APPLICATIONS

This application is based on and claims priority under 35 USC 119 from Japanese Patent Application No. 2013-152415 filed Jul. 23, 2013.

### BACKGROUND

(i) Technical Field

The present invention relates to a power management system and a non-transitory computer readable medium.

(ii) Related Art

Power-saving promotion systems have been installed in which an electric power company sets a power-saving target value (energy-saving target value) for each electric power consumer so as to promote power saving. Each power consumer takes various power-saving actions in order to achieve the set power-saving target value.

### SUMMARY

According to an aspect of the invention, there is provided a power management system including a detector, a demand estimation unit, and a distribution unit. The detector detects one or more devices which are located within an area and which consume electric power. The demand estimation unit estimates an electric power demand in the area on the basis of the devices detected by the detector. The distribution unit distributes an area power-saving target value to the area on the basis of the electric power demand estimated by the demand estimation unit and an overall power-saving target value set in advance. In response to a change in a state of the devices in the area to which the area power-saving target value has been distributed by the distribution unit, the demand estimation unit estimates an updated electric power demand on the basis of the state of the devices that has changed. The distribution unit updates the area power-saving target value on the basis of the updated electric power demand estimated by the demand estimation unit, and distributes the updated area power-saving target value to the area.

### BRIEF DESCRIPTION OF THE DRAWINGS

Exemplary embodiments of the present invention will be described in detail based on the following figures, wherein:

FIG. 1 illustrates an overall configuration of a power management system according to exemplary embodiments;

FIG. 2 is a schematic diagram illustrating a configuration of the power management system;

FIG. 3 is a schematic diagram illustrating a configuration of the power management system;

FIG. 4 is a functional block diagram of a power management system according to a first exemplary embodiment;

FIG. 5 is a table illustrating location information acquired from a terminal device;

FIG. 6 is a table illustrating location information of an area;

FIGS. 7A to 7C are tables illustrating information regarding terminal devices located within the area;

FIG. 8 is a diagram of an operation flow of the power management system;

FIGS. 9A and 9B are tables illustrating information regarding terminal device(s) located within another area;

FIG. 10 is a functional block diagram of a power management system according to a second exemplary embodiment;

FIGS. 11A and 11B are tables illustrating past information of terminal devices;

FIG. 12 illustrates an operation flow of a past information acquisition unit and a demand estimation unit;

FIGS. 13A to 13C are graphs illustrating past power consumption data and estimation data;

FIG. 14 is a functional block diagram of a power management system according to a third exemplary embodiment;

FIG. 15 illustrates an operation flow of a demand-estimate-value calculation method;

FIG. 16A is a table illustrating identification information of each terminal device and FIG. 16B is a table illustrating printer information; and

FIG. 17 is a graph illustrating a relationship between the number of output pages and power consumption of the printer.

### DETAILED DESCRIPTION

Exemplary embodiments of the present invention will be described below with reference to the drawings.

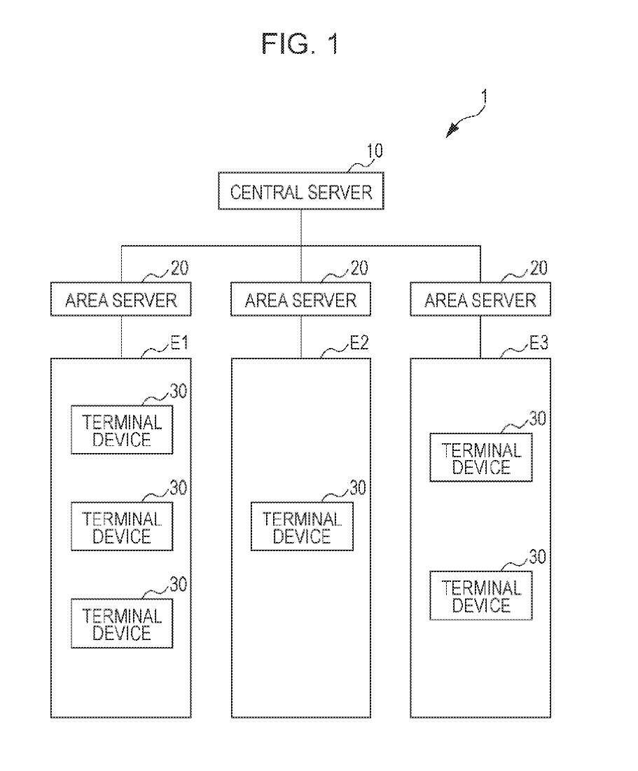

FIG. 1 illustrates an overall configuration of a power management system 1 according to an exemplary embodiment. As illustrated in FIG. 1, the power management system 1 includes a central server 10, multiple area servers 20, and multiple terminal devices 30. The central server 10 is connected to the area servers 20 via a network. The area servers 20 are each connected to the terminal device(s) 30 via a network. The power management system 1 is installed in various facilities, e.g., places of business, factories, and dwellings. In the case where the power management system 1 is installed in a place of business, the central server 10 is installed in, for example, a management server that centrally manages a network at the place of business and the area servers 20 are installed in, for example, individual departments (areas E1, E2, E3, and so on) within the place of business. In this case, the terminal devices 30 are, for example, devices such as computers, copiers, and mobile terminal devices installed within each department.

The central server 10 receives a preset power-saving target value (energy-saving target value) from an electric power company or a responsible person in the place of business, for example. The central server 10 also receives an estimate value of electric power demand (hereinafter, referred to as a demand estimate value) from each of the area servers 20. Based on the power-saving target value and the demand estimate values, the central server 10 distributes power-saving target values (hereinafter, referred to as area target values) to the respective area servers 20. In addition, in the case where the usage state of the terminal devices 30 has changed, the central server 10 receives an electric-power-demand estimate value after the change (hereinafter, referred to as an updated demand estimate value) from each of the area servers 20. The central server 10 then distributes power-saving target values (hereinafter, referred to as corrected area target values) obtained by correcting the original area target values in accordance with the updated demand estimate values, to the respective area servers 20. Note that the power-saving target value may represent an amount of electric power to be reduced or the upper limit of consumable electric power.

Upon receiving the area target value from the central server 10, the area server 20 distributes power-saving target values (hereinafter, referred to as terminal target values) to the respective terminal devices 30. Also, the area server 20 manages the number of terminal devices 30 located within a corresponding area and exit and entry (movement) of the terminal devices 30 to and from the area so as to manage an electric power demand of the area. In addition, the area server 20 manages exit and entry of users to and from the corresponding area. Further, in response to a change in an electric power demand because of entry or exit of the terminal device 30 or user within the corresponding area, the area server 20 calculates the updated demand estimate value and transmits the calculated updated demand estimate value to the central server 10.

The terminal device 30 receives the terminal target value from the area server 20. One or more terminal devices 30 are located in an area. The terminal device 30 may be, for example, a computer, copier, or air conditioner installed within an area in a fixed manner; or a mobile terminal device (such as a notebook personal computer (PC) or mobile device) which is portable from one area to another.

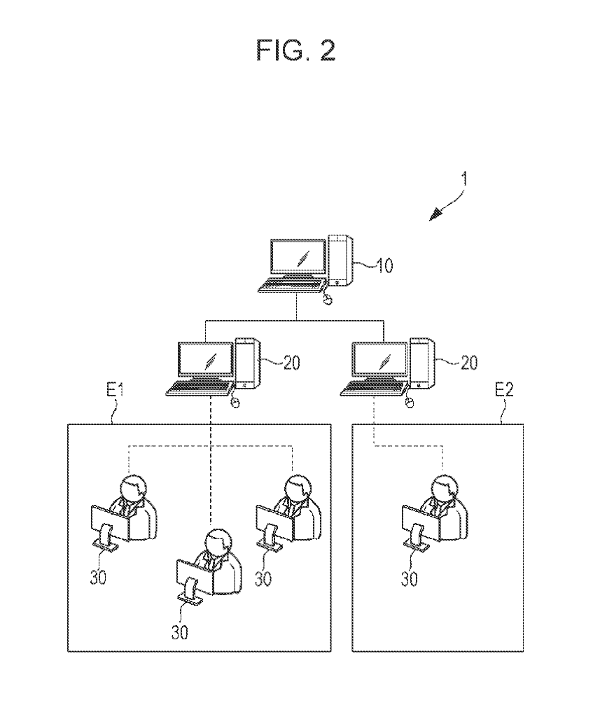

FIG. 2 is a schematic diagram illustrating a configuration of the power management system 1 installed in a place of business. As illustrated in FIG. 2, the power management system 1 includes the central server 10, two area servers 20 connected to the central server 10 via a network, three terminal devices 30 connected to the area server 20 for an office area (hereinafter, also referred to as an area) E1 via a network, and one terminal device 30 connected to the area server 20 for a meeting area (hereinafter, also referred to as an area) E2 via a network.

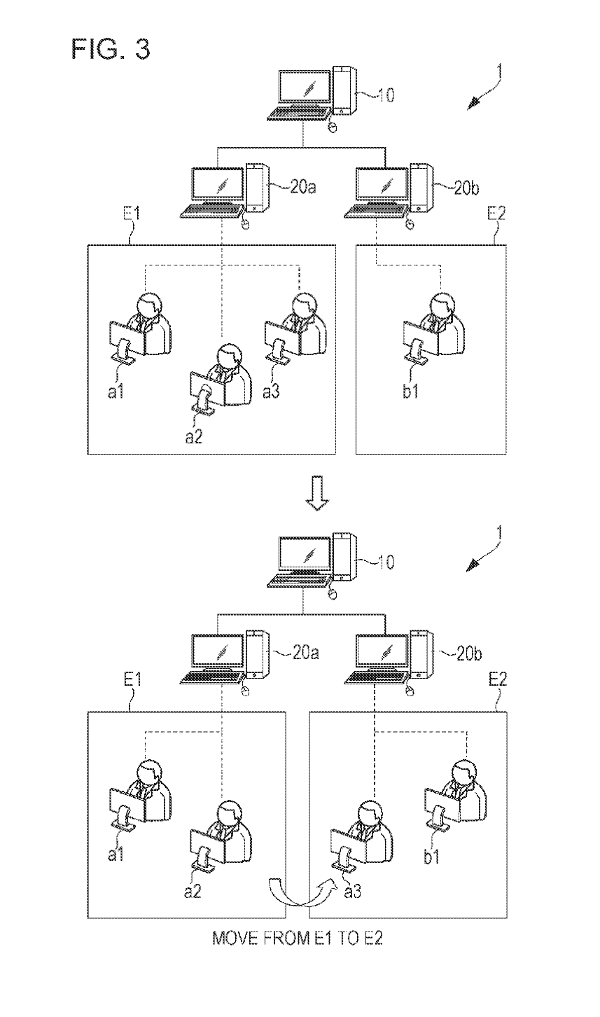

Referring to an example illustrated in FIG. 3, the overview of the power management system 1 will be described.

First, the central server 10 receives 1000 W/h as a power-saving target value from an electric power company. The central server 10 then distributes area target values in accordance with characteristics of individual areas. It is assumed here that three terminal devices a1, a2, and a3 each of which consumes 250 W/h are located within the office area E1 and one terminal device b1 which consumes 250 W/h is located within the meeting area E2. In this case, an area target value of 750 W/h is distributed to an area server 20a of the office area E1 and an area target value of 250 W/h is distributed to an area server 20b of the meeting area E2.

Suppose that the user who has been in the office area E1 moves to the meeting area E2 with the terminal device 3a (for example, a notebook PC) after the power-saving target values are distributed to the areas E1 and E2 as described above. In response to the movement of the terminal device a3, the area server 20a calculates the updated demand estimate value of the office area E1, and the area server 20b calculates the updated demand estimate value of the meeting area E2. In this case, the area server 20a obtains 500 W/h as the demand estimate value of the office area E1, and the area server 20b obtains 500 W/h as the demand estimate value of the meeting area E2.

After the demand estimate values are calculated by the area servers 20a and 20b, the central server 10 distributes corrected area target values to the area servers 20a and 20b in accordance with the demand estimate values. In this case, the central server 10 distributes a corrected area target value of 500 W/h to the area server 20a and a corrected area target value of 500 W/h to the area server 20b.

As described above, the power management system 1 includes a configuration that manages area target values of individual areas with consideration of a change in an electric power demand due to movement of a terminal device from one area to another area. The following describes specific configurations for implementing the above-described configuration. Note that the description will be given below by focusing on the area server 20a that manages the area E1 if necessary.

### First Exemplary Embodiment

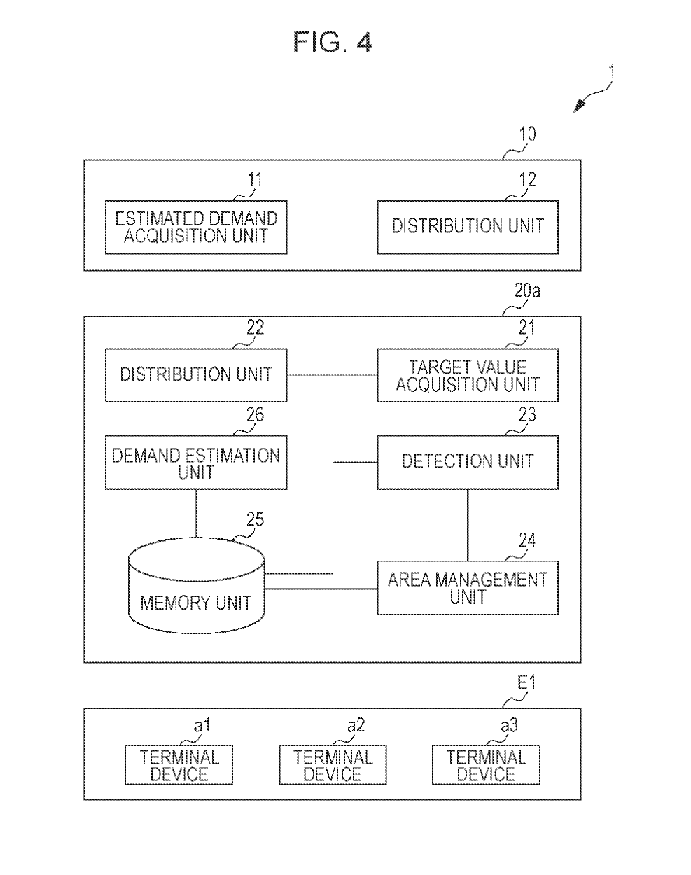

FIG. 4 is a functional block diagram of the power management system 1 according to a first exemplary embodiment. FIG. 4 illustrates the central server 10, the area server 20a that is connected to the central server 10 via a network and that manages the area E1, and three terminal devices a1, a2, and a3 that are connected to the area server 20a via a network and are located within the area E1. The terminal devices a1 and a2 are fixed computers (e.g., desktop PCs), whereas the terminal device a3 is a portable computer (e.g., a notebook PC).

The central server 10 includes an estimated demand acquisition unit 11 and a distribution unit 12.

In response to receipt of a power-saving target value P0 from an electric power company, for example, the estimated demand acquisition unit 11 requests the area servers 20 to calculate demand estimate values of corresponding areas, and acquires the demand estimate values of the corresponding areas from the area servers 20. The estimated demand acquisition unit 11 also acquires the updated demand estimate value from the area server 20 that manages the area in which the electric power demand has changed.

Based on the demand estimate values of the areas acquired by the estimated demand acquisition unit 11, the distribution unit 12 calculates area target values P1, P2, . . . , Pn (n represents the number of areas) of the respective areas, and distributes the calculated area target values to the corresponding area servers 20. Let J1, J2, J3, . . . , Jn denote demand estimate values of individual areas. For example, the area target value P1 is calculated using Equation (1) below.

P1=P0×J1/(J1+J2+J3+ . . . +Jn) (1)

Also, the power-saving target value P0 and the area target values satisfy a relationship represented by Equation (2) below.

P0=P1+P2+P3+ . . . +Pn (2)

In addition, based on the updated demand estimate value acquired by the estimated demand acquisition unit 11, the distribution unit 12 calculates a corrected area target value of the corresponding area, and distributes the calculated corrected area target value to the corresponding area server 20. The power-saving target value P0, the area target values, and the corrected area target values satisfy a relationship represented by Equation (3) below.

P0=P1+P2+P3+ . . . +Pn=P1′+P2′+P3+ . . . +Pn (3),

where P1′ and P2′ represent the corrected area target values of the areas in which the electric power demand has changed.

The distribution unit 12 determines whether or not a difference between the updated demand estimate value of an area acquired by the estimated demand acquisition unit 11 and the original demand estimate value of the area is larger than or equal to a threshold. If the difference is larger than or equal to the threshold, the distribution unit 12 calculates the corrected area target value of the area. If the difference is smaller than the threshold, the distribution unit 12 does not calculate the corrected area target value of the area, and does not perform the re-distribution process. Note that the threshold may be set to 10% of the original demand estimate value, for example.

The area server 20a includes a target value acquisition unit 21, a distribution unit 22, a detection unit 23, an area management unit 24, a memory unit 25, and a demand estimation unit 26.

The target value acquisition unit 21 acquires the area target value distributed by the distribution unit 12 of the central server 10. The target value acquisition unit 21 also acquires the corrected area target value distributed by the distribution unit 12 of the central server 10.

After the target value acquisition unit 21 has acquired the area target value, the distribution unit 22 distributes terminal target values to the respective terminal devices a1, a2, and a3. Also, after the target value acquisition unit 21 has acquired the corrected area target value, the distribution unit 22 distributes terminal target values to the terminal devices a1, a2, and a3 in accordance with the corrected area target value.

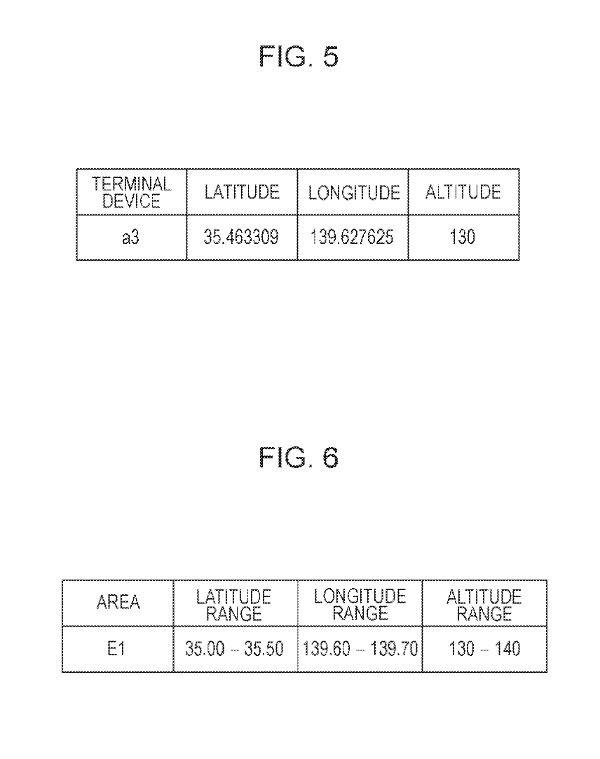

The detection unit 23 detects movement of the terminal device originally located within the area E1. The detection unit 23 transmits the detection result to the area management unit 24. For example, in the case where the terminal device a3 has been brought out from the area E1, the detection unit 23 transmits to the area management unit 24 information indicating that the terminal device a3 has been brought out from the area E1. Specifically, the detection unit 23 acquires location information (e.g., latitude, longitude, and altitude) from a location information transmission unit (e.g., a GPS unit) (not illustrated) included in each terminal device so as to detect movement. FIG. 5 illustrates location information acquired from the terminal device a3, and FIG. 6 illustrates location information of the area E1. The detection unit 23 determines whether or not the terminal device a3 has been moved by comparing the location information illustrated in FIG. 5 with the location information illustrated in FIG. 6. Note that the location information of the area E1 illustrated in FIG. 6 is stored in the memory unit 25. Also, the method for detecting movement of a terminal device used by the detection unit 23 is not limited to this particular method.

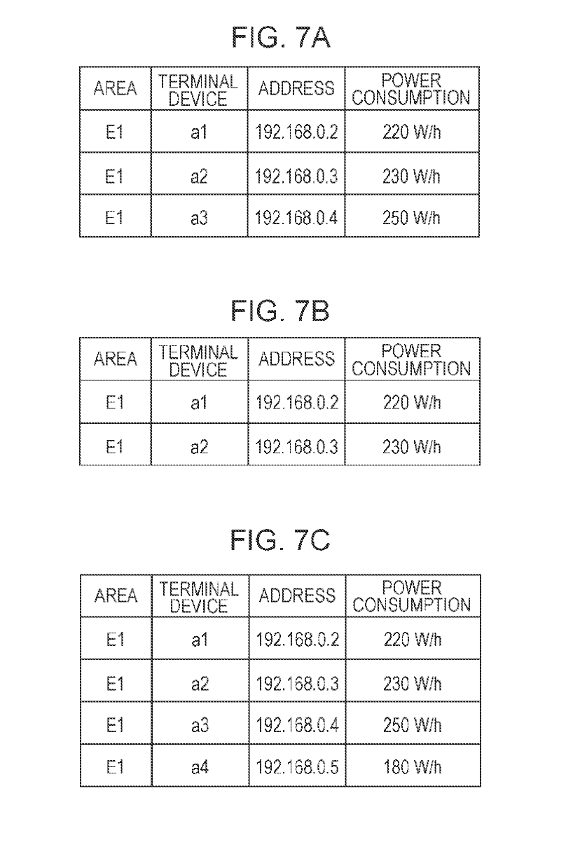

The area management unit 24 manages the terminal devices 30 located within the area E1. Also, the area management unit 24 updates information regarding the terminal devices 30 located within the area E1 upon receiving the detection result from the detection unit 23. FIGS. 7A to 7C each illustrate a table of information regarding the terminal devices 30 located within the area E1. The tables illustrated in FIGS. 7A to 7C are stored in the memory unit 25, and information stored in the tables is updated by the area management unit 24 whenever needed. For example, in the case where the terminal device a3 is brought out from the area E1, the area management unit 24 deletes information regarding the terminal device a3 from the table in accordance with the detection result obtained by the detection unit 23 (see FIG. 7B). In the case where a terminal device a4 is brought into the area E1, the area management unit 24 adds information regarding the terminal device a4 in accordance with the detection result obtained by the detection unit 23 (see FIG. 7C). Note that information stored in the tables illustrated in FIGS. 7A to 7C may be acquired from a management server (not illustrated) provided separately from the area server 20.

The demand estimation unit 26 calculates the demand estimate value of the area E1 upon receiving a demand-estimate-value calculation request from the estimated demand acquisition unit 11 of the central server 10, and transmits the calculated demand estimate value to the central server 10. Specifically, upon receiving a demand-estimate-value calculation request, the demand estimation unit 26 calculates the demand estimate value of the area E1 on the basis of the information regarding the terminal devices 30 (such as the table illustrated in FIG. 7A) stored in the memory unit 25. For example, in the case of FIG. 7A, the demand estimate value is 700 W/h. Also, once the area management unit 24 updates the information regarding the terminal devices 30, the demand estimation unit 26 calculates the updated demand estimate value of the area E1 on the basis of information stored in the updated table (illustrated in FIG. 7B or 7C), and transmits the calculated updated demand estimate value to the central server 10. For example, the demand estimate value is 550 W/h the in the case of FIG. 7B, and is 880 W/h in the case of FIG. 7C.

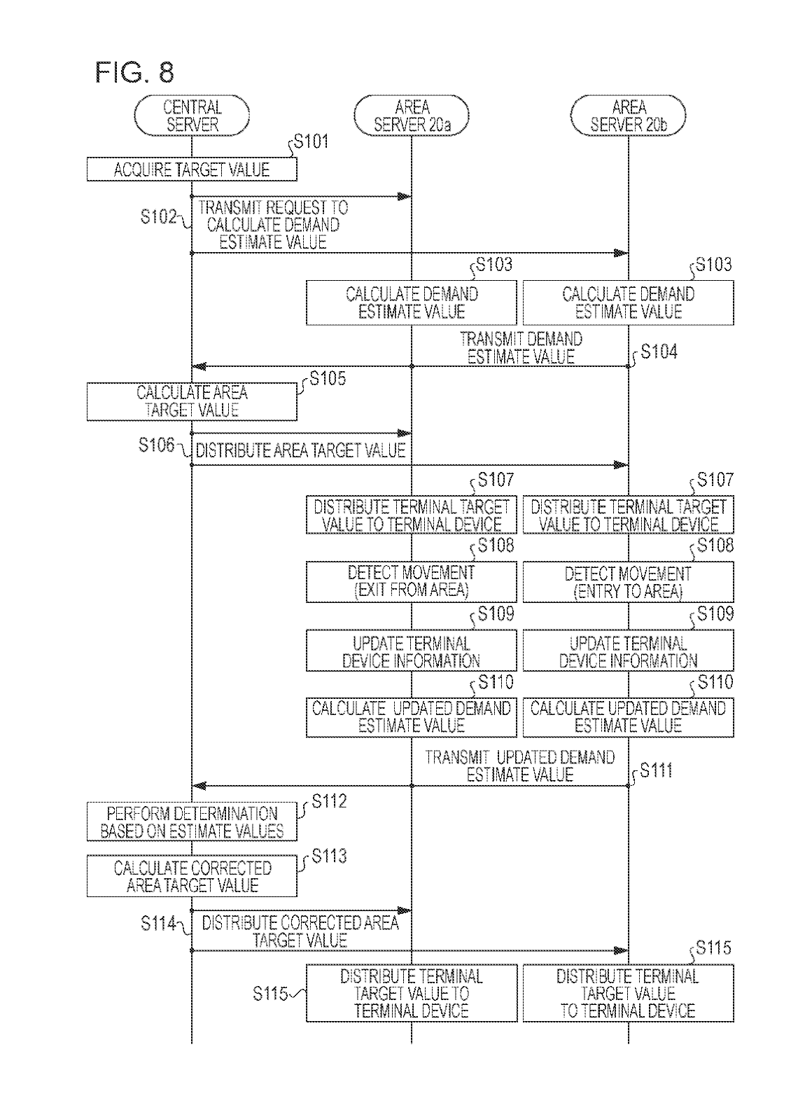

FIG. 8 is a diagram of an operation flow of the power management system 1. Here, the description will be given of an operation performed by the power management system 1 in the case where the terminal device a3 originally located within the office area E1 is moved to the meeting area E2 as illustrated in the example of FIG. 3. Note that a server that manages the area E1 is referred to as the area server 20a, and a server that manages the area E2 is referred to as the area server 20b.

Once the central server 10 receives 1000 W/h as a power-saving target value from an electric power company (S101), the estimated demand acquisition unit 11 requests the area servers 20a and 20b to calculate demand estimate values of the areas E1 and E2, respectively (S102).

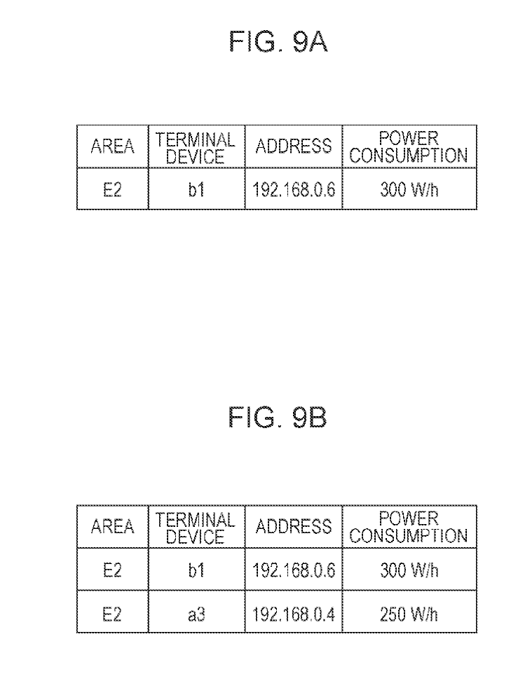

Once the area server 20a receives the demand-estimate-value calculation request from the estimated demand acquisition unit 11 of the central server 10, the demand estimation unit 26 of the area server 20a calculates the demand estimate value of the area E1 by referring to the table (see FIG. 7A) stored in the memory unit 25 (S103). In this case, the demand estimation unit 26 of the area server 20a obtains 700 W/h as the demand estimate value of the area E1. Similarly, once the area server 20b receives the demand-estimate-value calculation request from the estimated demand acquisition unit 11 of the central server 10, the demand estimation unit 26 of the area server 20b calculates the demand estimate value of the area E2 by referring to a table (see FIG. 9A) stored in the memory unit 25 (S103). In this case, the demand estimation unit 26 of the area server 20b obtains 300 W/h as the demand estimate value of the area E2. The area servers 20a and 20b each transmit the calculated demand estimate value to the central server 10 (S104).

Once the estimated demand acquisition unit 11 of the central server 10 acquires the demand estimate values from the area servers 20a and 20b, the distribution unit 12 calculates area target values of the areas E1 and E2 using Equation (1) on the basis of the demand estimate values and the power-saving target value (S105). In this case, the distribution unit 12 obtains 700 W/h as the area target value of the area E1 and 300 W/h as the area target value of the area E2 on the basis of the demand estimate values (700 W/h and 300 W/h) and the power-saving target value (1000 W/h). The distribution unit 12 distributes the area target value of 700 W/h to the area server 20a, and the area target value of 300 W/h to the area server 20b (S106).

Once the target value acquisition unit 21 of the area server 20a acquires the area target value of 700 W/h from the central server 10, the distribution unit 22 distributes terminal target values to the terminal devices a1, a2, and a3 (S107). In this case, the distribution unit 22 distributes 220 W/h to the terminal device a1, 230 W/h to the terminal device a2, and 250 W/h to the terminal device a3. Similarly, once the target value acquisition unit 21 of the area server 20b acquires the area target value of 300 W/h from the central server 10, the distribution unit 22 distributes a terminal target value to the terminal device b1 (S107). In this case, 300 W/h is distributed to the terminal device b1 located within the area E2.

Then, the terminal device a3 originally located within the area E1 is moved to the area E2 (see FIG. 3). In this case, the detection unit 23 of the area server 20a detects that the terminal device a3 has been brought out from the area E1, and the detection unit 23 of the area server 20b detects that the terminal device a3 has been brought into the area E2 (S108).

Then, the area management unit 24 of the area server 20a deletes information regarding the terminal device a3 from the table (see FIG. 7A) stored in the memory unit 25 (see FIG. 7B) (S109). Also, the area management unit 24 of the area server 20b adds the information regarding the terminal device a3 to the table (see FIG. 9A) stored in the memory unit 25 (see FIG. 9B) (S109).

Then, the demand estimation unit 26 of the area server 20a calculates the updated demand estimate value of the area E1 by referring to the table (see FIG. 7B) stored in the memory unit 25 (S110). In this case, the demand estimation unit 26 of the area server 20a obtains 450 W/h as the updated demand estimate value of the area E1. Similarly, the demand estimation unit 26 of the area server 20b calculates the updated demand estimate value of the area E2 by referring to the table (see FIG. 9B) stored in the memory unit 25 (S110). In this case, the demand estimation unit 26 of the area server 20b obtains 550 W/h as the update demand estimate value of the area E2. The area servers 20a and 20b each transmit the calculated updated demand estimate value to the central server 10 (S111).

Once the estimated demand acquisition unit 11 of the central server 10 acquires the updated demand estimate values from the area servers 20a and 20b, the distribution unit 12 determines, for each of the areas E1 and E2, whether a difference between the updated demand estimate value and the original demand estimate value is larger than or equal to a threshold (e.g., 10% of the original demand estimate value) (S112). If the difference is larger than or equal to the threshold, the distribution unit 12 calculates corrected area target values of the areas E1 and E2. In this case, as for the area E1, a difference between the updated demand estimate value of 450 W/h and the original demand estimate value of 700 W/h is 250 W/h and is larger than 10% (70 W/h) of the original demand estimate value of 700 W/h. As for the area E2, a difference between the updated demand estimate value of 550 W/h and the original demand estimate value of 300 W/h is 250 W/h and is larger than 10% (30 W/h) of the original demand estimate value of 300 W/h. Accordingly, the distribution unit 12 calculates the corrected area target values of the areas E1 and E2 using Equation (1) on the basis of the updated demand estimate values and the power-saving target value (S113). In this case, the distribution unit 12 obtains 450 W/h as the corrected area target value of the area E1 and 550 W/h as the corrected area target value of the area E2 on the basis of the updated demand estimate values (450 W/h and 550 W/h) and the power-saving target value (1000 W/h). The distribution unit 12 distributes the corrected area target value of 450 W/h to the area server 20a and the corrected area target value of 550 W/h to the area server 20b (S114).

Once the target value acquisition unit 21 of the area server 20a acquires the corrected area target value of 450 W/h from the central server 10, the distribution unit 22 distributes terminal target values to the terminal devices a1 and a2 (S115). In this case, the distribution unit 22 distributes 220 W/h to the terminal device a1 and 230 W/h to the terminal device a2. Similarly, once the target value acquisition unit 21 of the area server 20b acquires the corrected area target value of 550 W/h from the central server 10, the distribution unit 22 distributes terminal target values to the terminal devices b1 and a3 (S115). In this case, the distribution unit 22 distributes 300 W/h to the terminal device b1 and 250 W/h to the terminal device a3.

### Second Exemplary Embodiment

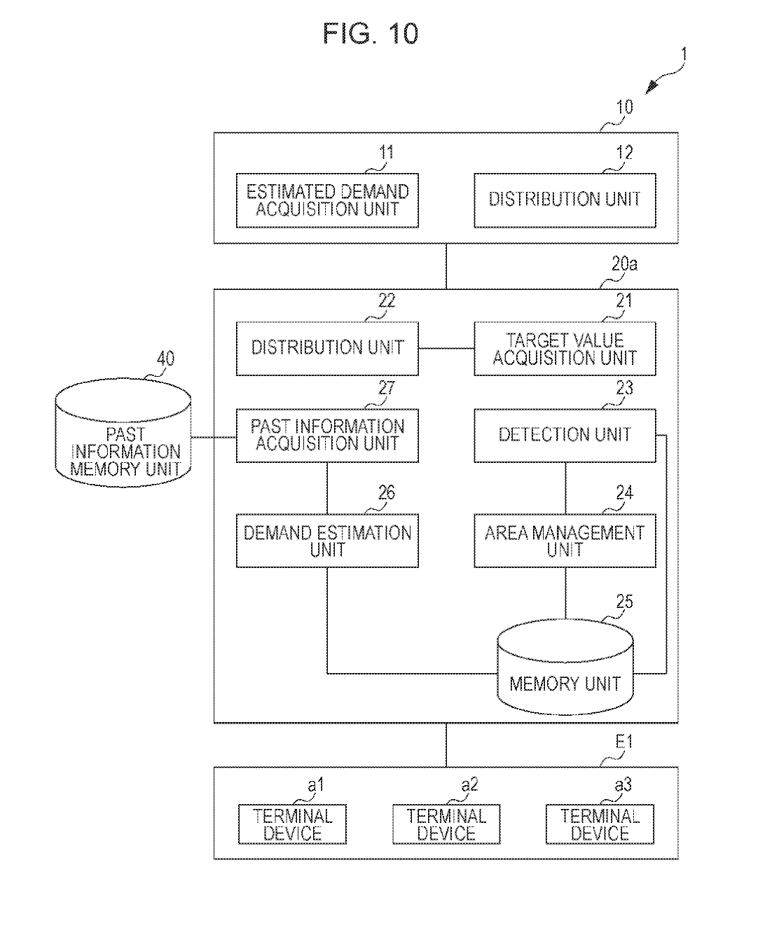

FIG. 10 is a functional block diagram of the power management system 1 according to a second exemplary embodiment. The power management system 1 according to the second exemplary embodiment is equivalent to the power management system 1 according to the first exemplary embodiment in which the area server 20 further includes a past information acquisition unit 27. The following description focuses on differences from the power management system 1 according to the first exemplary embodiment, and a redundant description will be omitted.

In the power management system 1 according to the second exemplary embodiment, the demand estimation unit 26 calculates a demand estimate value with consideration of information regarding the past usage state of the terminal device 30 as well as information regarding the terminal devices 30 (table illustrated in FIG. 7A) stored in the memory unit 25.

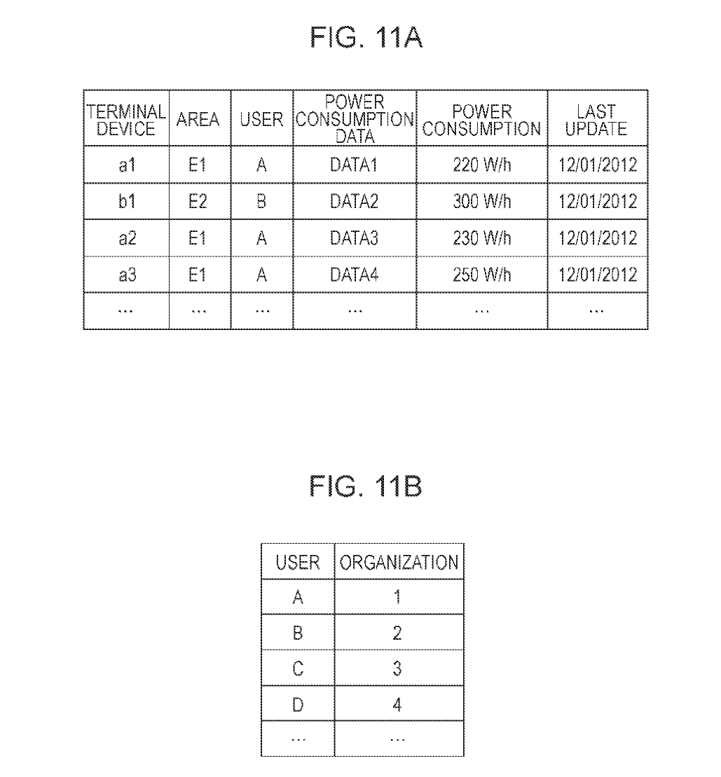

The past information acquisition unit 27 acquires information regarding the past usage state of the terminal device 30 (e.g., past demand estimate values) from a past information memory unit 40. The past information memory unit 40 stores information regarding the terminal devices 30 located in all areas. Specifically, as illustrated in FIG. 11A, the terminal device 30, an area in which the terminal device 30 is located, a user of the terminal device 30, past power consumption data of the terminal device 30, power consumption, and the last update date are associated with one another in the table. Note that the past information memory unit 40 may be included in the central server 10 or a management server (not illustrated) provided separately from the central server 10.

Upon receiving a demand-estimate-value calculation request from the estimated demand acquisition unit 11 of the central server 10, the demand estimation unit 26 calculates a demand estimate value of the area E1 on the basis of the information regarding the terminal devices 30 (table illustrated in FIG. 7A) stored in the memory unit 25 and the information regarding the past usage state of the terminal device 30 (table illustrated in FIG. 11A) acquired by the past information acquisition unit 27. The demand estimation unit 26 transmits the calculated demand estimate value to the central server 10.

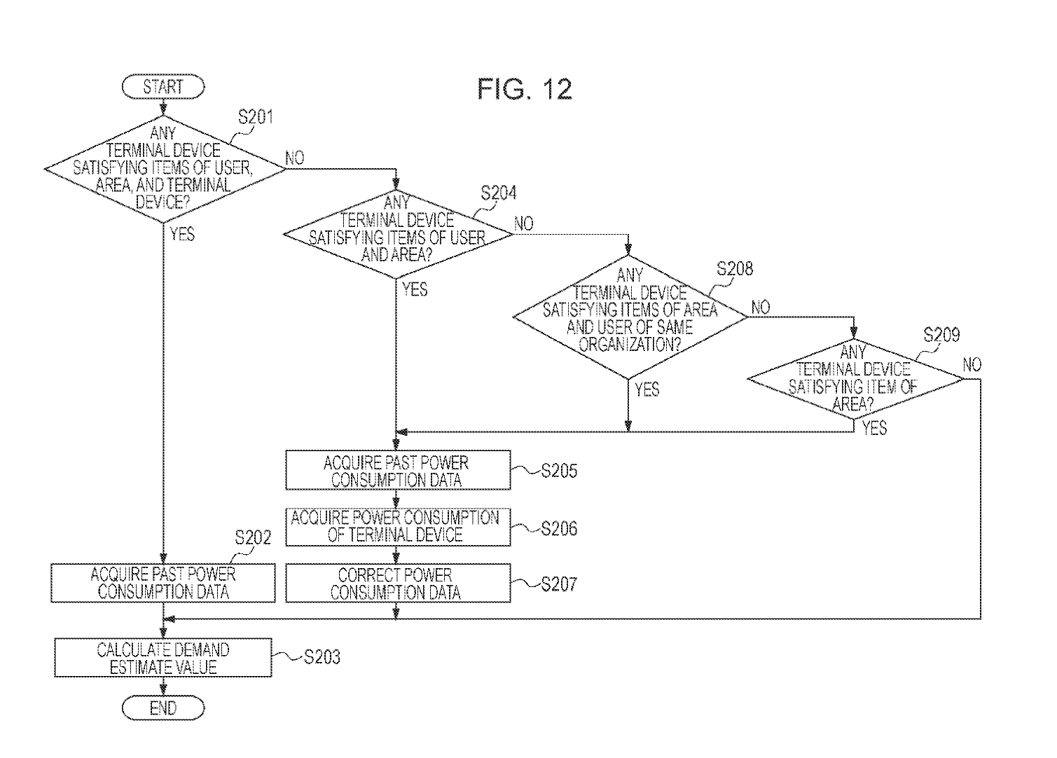

Now, the demand-estimate-value calculation method will be described. FIG. 12 illustrates an operation flow of the past information acquisition unit 27 and the demand estimation unit 26. Here, the case of calculating the demand estimate value of the area E1 will be described by way of example.

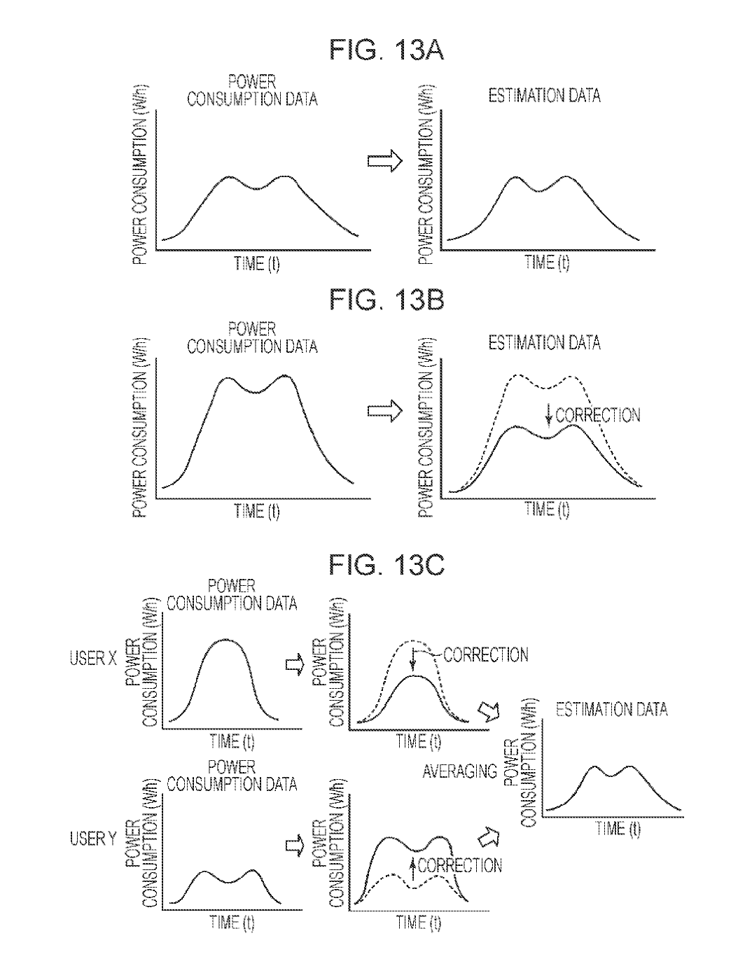

First, the past information acquisition unit 27 determines whether or not a terminal device that matches any of records in terms of items of the area, user, and terminal device currently exists within the area E1, by referring to the information regarding the terminal devices 30 (table illustrated in FIG. 11A) (S201). If there is such a terminal device, the past information acquisition unit 27 acquires the past power consumption data of the terminal device (S202). The demand estimation unit 26 calculates a demand estimate value on the basis of the acquired power consumption data (S203). FIG. 13A illustrates past power consumption data and estimation data used to calculate the demand estimate value in the case where all the items of the area, user, and terminal device are satisfied. The horizontal axis and the vertical axis of graphs illustrated in FIGS. 13A to 13C represent time and power consumption, respectively.

If no terminal device that matches any of the records in terms of all the items of the area, user, and terminal device exists within the area E1 (NO in S201) but a terminal device that matches any of the records in terms of the items of the area and user exists within the area E1 (YES in S204), the past information acquisition unit 27 acquires the past power consumption data of the terminal device (S205). Then, the demand estimation unit 26 acquires the power consumption of the terminal device by referring to the table illustrated in FIG. 11A (S206). Then, the demand estimation unit 26 corrects the power consumption data acquired by the past information acquisition unit 27 on the basis of the acquired power consumption (S207), and calculates the demand estimate value on the basis of the corrected power consumption data (S203). FIG. 13B illustrates past power consumption data and corrected estimation data used to calculate the demand estimate value in the case where the area E1 and the user are satisfied. In this case, a demand estimate value based on the usage method or usage tendency of the user is calculated.

If no terminal device that matches any of the records in terms of the items of the area and user exists within the area E1 (NO in S204) but a terminal device used by a user belonging to the same organization exists (YES in S208), the past information acquisition unit 27 acquires the past power consumption data of the terminal device (S205). In this case, a demand estimate value based on the usage method or usage tendency of the users belonging to the same organization is calculated. Note that information regarding users and organizations to which users belong are associated with each other in the table illustrated in FIG. 11B. FIG. 13C illustrates pieces of past power consumption data of the terminal device used by users belonging to the same organization and corrected estimation data used to calculate the demand estimate value. Note that FIG. 13C illustrates the case where multiple users X and Y belong to the same organization. In this case, data obtained by averaging pieces of corrected power consumption data is used as estimation data.

If no terminal device used by a user belonging to the same organization exists within the area E1 (NO in S208), the past information acquisition unit 27 acquires past power consumption data of a given terminal device located within the area E1 (YES in S209). If there is no terminal device within the area E1 (NO in S209), the demand estimation unit 26 calculates the demand estimate value on the basis of the information regarding the terminals 30 (table illustrated in FIG. 7A) stored in the memory unit 25 (S203).

### Third Exemplary Embodiment

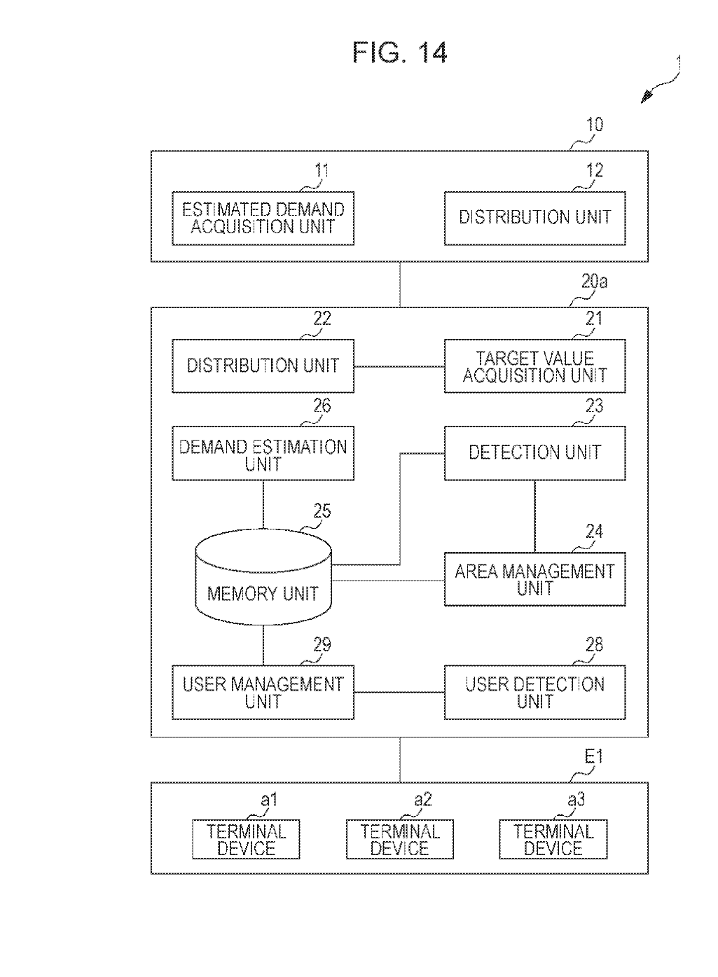

FIG. 14 is a functional block diagram of the power management system 1 according to a third exemplary embodiment. The power management system 1 according to the third exemplary embodiment is equivalent to the power management system 1 according to the first exemplary embodiment in which the area server 20 further includes a user detection unit 28 and a user management unit 29. The following description focuses on differences from the power management system 1 according to the first exemplary embodiment, and a redundant description will be omitted.

The user detection unit 28 detects a user located within the area E1. For example, the user detection unit 28 detects a user located within the area E1 by acquiring an entry-exit record based on the ID card carried by the user. In the case where the user carries a GPS unit, the user detection unit 28 may detect the user using the GPS unit. The user detection unit 28 transmits the detection result to the user management unit 29. Also, in the case where a user has exited from the area E1 or in the case where the user has entered the area E1, the user detection unit 28 transmits to the user management unit 29 information indicating that the user has exited from the area E1 or the user has entered the area E1.

The user management unit 29 manages user(s) located within the area E1. The user management unit 29 also updates information regarding user(s) located within the area E1 upon receiving the detection result from the user detection unit 28. The information regarding user(s) located within the area E1 is stored in the memory unit 25 and is updated by the user management unit 29 whenever needed. The information regarding individual users may be acquired from a management server (not illustrated) that is provided separately from the area server 20 and that centrally manages information regarding all users.

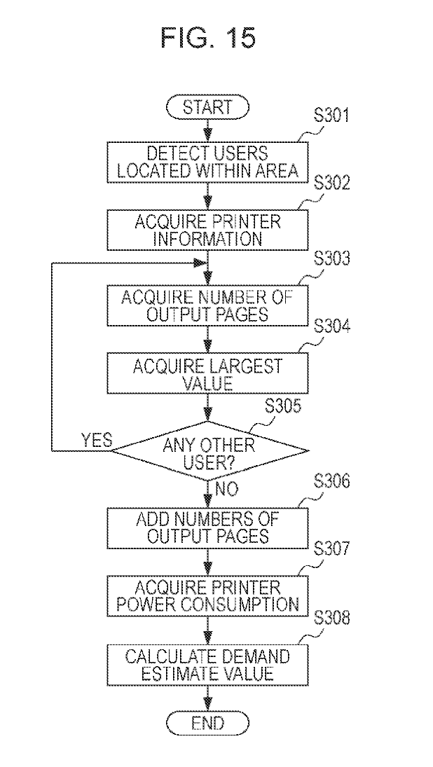

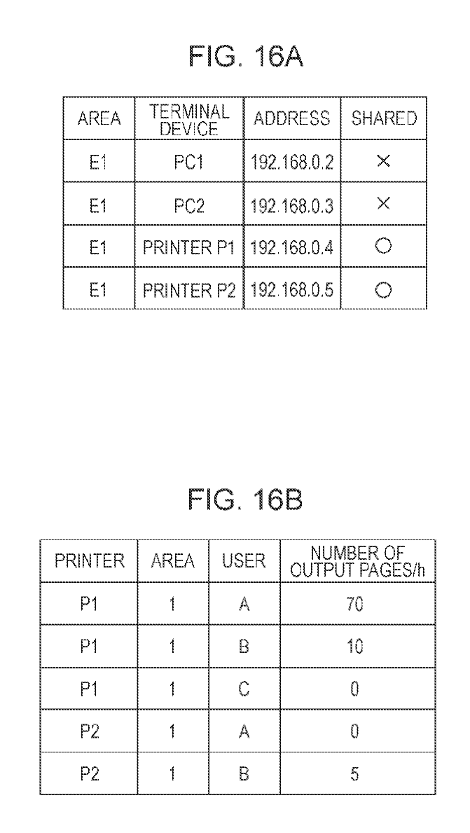

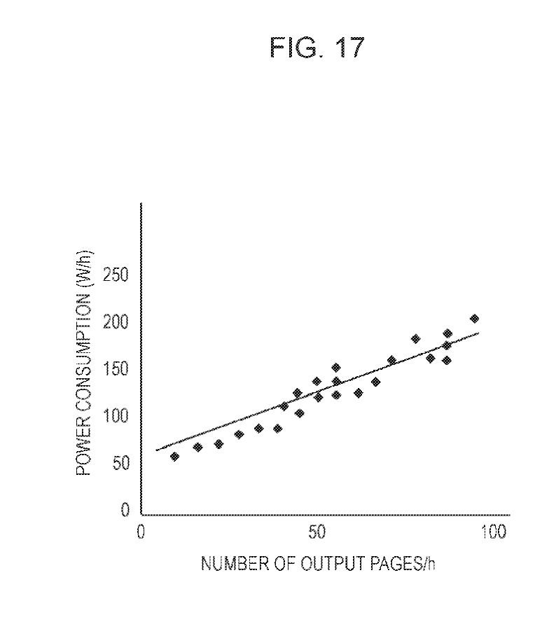

Now, the demand-estimate-value calculation method to be performed upon detection of a user will be described with reference to an operation flow illustrated in FIG. 15. Here, the case where users A, B, and C are located within the area E1 will be described by way of example. Also, it is assumed that two PCs and two printers P1 and P2 used by multiple users are located within the area E1. The memory unit 25 stores therein a table including identification information of each terminal device (see FIG. 16A) and a table including information regarding each printer (see FIG. 16B). Note that the information regarding each printer may be acquired by the area management unit 24 from a management server (not illustrated) that centrally manages information regarding all printers.

First, the user detection unit 28 detects the users A, B, and C located within the area E1 (S301). The user management unit 29 stores information regarding the users A, B, and C in the memory unit 25. Then, the demand estimation unit 26 acquires information regarding the printers located within the area E1 (see FIG. 16B) from the memory unit 25 (S302).

Then, the demand estimation unit 26 acquires, for each printer, the number of output pages which serves as the actual usage state of the printer by the user (S303). In this case, as for the user A, 70 pages/hour and 0 pages/hour are acquired for the printers P1 and P2, respectively. Then, the demand estimation unit 26 acquires the largest value from among the acquired numbers of output pages (S304). In this case, 70 pages/hour is acquired.

The process then proceeds to S305. If there is another user, the process returns to S303. In this case, as for the user B, 10 pages/hour and 5 pages/hour are acquired for the printers P1 and P2, respectively. The demand estimation unit 26 acquires the largest value from among the numbers of output pages (S304). In this case, 10 pages/hour is acquired. Similarly, the processing of S303 is also performed for the user C, and 0 pages/hour for the printer P1 is acquired for the user C in this case.

After the above-described processing has been performed for all users located within the area E1, the demand estimation unit 26 adds the acquired numbers of output pages (largest values) together (S306). In this case, the total is 80 pages/hour. Then, the demand estimation unit 26 acquires printer power consumption corresponding to the total of the numbers of output pages (largest values) in accordance with a graph representing a relationship between the number of output pages and printer power consumption (see FIG. 17) (S307). In this case, 150 W/h corresponding to the total of 80 pages/hour is acquired.

The demand estimation unit 26 calculates the demand estimate value or the updated demand estimate value of the area E1 by adding the acquired printer power consumption to power consumption of other terminal devices PC1 and PC2 acquired through the processing of the first exemplary embodiment (see FIG. 8) (S308).

For example, if the user A exits from the area E1, the processing illustrated in FIG. 15 is performed, and the updated demand estimate value of the area E1 is calculated. In this case, the total number of output pages is reduced from 80 pages/hour to 10 pages/hour. Because the printer power consumption corresponding to total number of output pages of 10 pages/hour is 50 W/h, the updated demand estimate value reduces by at least 100 W/h which is a reduction in the printer power consumption.

The present invention is not limited to the exemplary embodiments described above. In the exemplary embodiments described above, distribution processing is performed whenever movement of a terminal device or user from one area to another is detected; however, the configuration is not limited to this one, and the distribution processing may be performed at certain intervals or on a certain date and time (for example, once in the morning/afternoon every day, once at every weekend, or once at the end of every month).

The functions of the individual units included in the above-described power management system 1 may be realized in the following manner. A computer including a controller such as a central processing unit (CPU), a memory unit such as a memory, and an input/output unit that transmits and receives data to and from an external device reads and executes a program stored on a computer readable information storage medium. The program may be supplied to the power management system 1, which serves as the computer, via an information storage medium such as an optical disc, magnetic disk, magnetic tape, magneto-optical disk, or flash memory; or via a data communication network such as the Internet.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A power management system comprising:
a detector that detects one or more devices which are located within an area and which consume electric power;
a demand estimation unit that estimates an electric power demand in the area on the basis of the devices detected by the detector; and
a distribution unit that distributes an area power-saving target value to the area on the basis of the electric power demand estimated by the demand estimation unit and an overall power-saving target value set in advance, wherein
in response to a change in a state of the devices in the area to which the area power-saving target value has been distributed by the distribution unit, the demand estimation unit estimates an updated electric power demand on the basis of the state of the devices that has changed, and
the distribution unit updates the area power-saving target value on the basis of the updated electric power demand estimated by the demand estimation unit, and distributes the updated area power-saving target value to the area.

2. The power management system according to claim 1, wherein the detector detects the change in the state of the devices by detecting entry of a device into the area or exit of a device from the area.

3. The power management system according to claim 2, wherein in a case where a device among the devices originally located within a first area is moved to a second area, the demand estimation unit estimates the updated electric power demand in the first area by subtracting a power consumption set for the moved device from the electric power demand estimated before the movement and estimates the updated electric power demand in the second area by adding the power consumption set for the moved device to the electric power demand estimated before the movement.

4. The power management system according to claim 1, wherein the detector detects the change in the state of the devices by detecting entry of a user who uses a device into the area or exit of a user who uses a device from the area.

5. The power management system according to claim 1, wherein the distribution unit updates the area power-saving target value in a case where a difference between the electric power demand estimated by the demand estimation unit before the change in the state of the devices and the updated electric power demand estimated by the demand estimation unit after the change in the state of the devices is larger than or equal to a threshold.

6. The power management system according to claim 1, wherein the demand estimation unit estimates the electric power demand in the area or the updated electric power demand in the area by adding power consumptions set for all the devices that are located within the area and detected by the detector together.

7. The power management system according to claim 1, wherein the demand estimation unit estimates an electric power demand of a device among the devices on the basis of log data of a past power consumption of the device detected by the detector.

8. The power management system according to claim 1, comprising:
a central server that includes the distribution unit and that acquires the power-saving target value; and
a plurality of area servers each of which is connected to the central server via a network, and includes the detector and the demand estimation unit.

9. The power management system according to claim 1, wherein the distribution unit distributes the area power-saving target value to the individual devices located within the area.

10. The power management system according to claim 1, wherein the state of the devices includes the number of devices located within the area.

11. A power management system, comprising:
a detector that detects, in each of a plurality of areas, one or more devices which are located within the area and which consume electric power;
a demand estimation unit that estimates electric power demands each for a corresponding one of the plurality of areas on the basis of the devices detected by the detector; and
a distribution unit that distributes area power-saving target values to the plurality of areas on the basis of the electric power demands estimated by the demand estimation unit and an overall power-saving target value set in advance, wherein
the plurality of areas include a first area,
in response to a change in the number of devices in the first area to which the area power-saving target value has been distributed by the distribution unit, the demand estimation unit estimates an updated electric power demand in the first area on the basis of the number of devices that has changed, and
the distribution unit updates the area power-saving target value of the first area on the basis of the updated electric power demand estimated by the demand estimation unit, and distributes the updated area power-saving target value to the first area.

12. A non-transitory computer readable medium storing a program causing a computer to execute a process for power management, the process comprising:
detecting one or more devices which are located within an area and which consume electric power;
estimating an electric power demand in the area on the basis of the detected devices;
distributing an area power-saving target value to the area on the basis of the estimated electric power demand and an overall power-saving target value set in advance;
estimating, in response to a change in a state of the devices in the area to which the area power-saving target value has been distributed, an updated electric power demand on the basis of the state of the devices that has changed;
updating the area power-saving target value on the basis of the estimated updated electric power demand; and
distributing the updated area power-saving target value to the area.
